(19) United States
(12) Patent Application Publication
(10) Pub. No.: US 2008/0220109 A1
(43) Pub. Date: Sep. 11, 2008

(54) MOLDING TOOL

(75) Inventors: Hirotaka ITO, Kobe-shi (JP); Kenji Yamamoto, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel Ltd.), Kobe-shi (JP)

(21) Appl. No.: 12/028,267

(22) Filed: Feb. 8, 2008

(30) Foreign Application Priority Data
Mar. 6, 2007 (JP) 2007-056076

(51) Int. Cl. B29C 41/00

(52) U.S. Cl. 425/90

(57) ABSTRACT

A molding tool has a base surface hard to be roughened by an etching process for removing a worn DLC film. The molding tool is provided with an intermediate film coating a base surface of the molding tool, and a diamondlike carbon film coating the intermediate film. The intermediate film is formed of a material having a composition represented by (Cr₁₋ₐSiₐ) (BₓC_{y}N_{1-x-y}) meeting conditions expressed by inequalities: 0.5≦a≦0.95, 0≦x≦0.2, and 0≦y≦0.5, where a is the atomic percent of Si, x is the atomic percent of B, and y is the atomic percent of C, by using a process gas pressure between 0.2 and 0.5 Pa.

### BACKGROUND OF THE INVENTION

1. Field of the Invention

The present invention relates to a molding tool. More particularly, the present invention relates to a molding tool for molding a glass lens or a resin molding

2. Description of the Related Art

A resin molding tool having a base surface coated with a carbon film of diamond structure is disclosed in JP-A 2005-342922. This known resin molding tool can mold moldings without using any mold lubricant. The term, “carbon film of diamond structure” is synonymous with the term, “diamondlike carbon film”. Hereinafter, a carbon film of diamond structure will be referred to as a “DLC film (diamondlike carbon film)”.

Durability of a molding tool having a base surface coated with a DLC film is higher than that of a molding tool having an uncoated base surface. However, since the durability of a DLC film is limited, maintenance work needs to be executed periodically to remove a worn DLC film and to coat the base surface with a new DLC film to extend the life of the molding tool.

The DLC film is removed by an etching process, such as a dc glow discharge etching process. The dc glow discharge process often etches not only the DLC film, but also the base surface of the molding tool. Consequently, it is possible that the base surface of the molding tool is roughened due to the selective etching of components of the material of the molding tool.

If a DLC film is deposited on the thus roughened base surface of the molding tool, the surface of the DLC film inevitably has a rough surface. Therefore, the roughness of the roughened base surface of the molding tool needs to be adjusted before being coated with a DLC film, which requires much time and cost. A molding tool for molding a glass lens or a resin molding, in particular, needs to have a base surface very excellent in smoothness. Therefore, the surface roughness adjustment of the base surface of the molding tool requires much time and cost.

### SUMMARY OF THE INVENTION

The present invention has been made in view of the foregoing problems and it is therefore an object of the present invention to provide a molding tool having a base surface coated with a DLC film and hard to be roughened by an etching process for removing the DLC film.

One aspect of the present invention is directed to a molding tool provided with an intermediate film coating a base surface of the molding tool, and a DLC film coating the intermediate film; wherein the intermediate film is formed of a material having a composition represented by (Cr₁₋ₐSiₐ) (BₓC_{y}N_{1-x-y}) meeting conditions expressed by Inequalities:

0.5≦a≦0.95 (1)

0≦x≦0.2 (2)

0≦y≦0.5 (3),

where a is the atomic percent of Si, x is the atomic percent of B, and y is the atomic percent of C, by using a process gas pressure between 0.2 and 0.5 Pa.

In the molding tool according to the aspect, the intermediate film may have a thickness between 20 and 1000 nm.

The molding tool according to the aspect has the base surface hard to be roughened by an etching process for removing the DLC film. Therefore, the base surface of the molding tool does not need to be processed by a surface roughness adjusting process before depositing a new DLC film on the base surface.

### BRIEF DESCRIPTION OF THE DRAWINGS

The above and other objects, features and advantages of the present invention will become more apparent from the following description taken in connection with the accompanying drawings, in which:

FIG. 1 is a graph comparatively showing the variation of the respective values of center line average roughness Ra of samples in examples of the present invention and comparative examples with bias voltage used for depositing a film;

FIG. 2 is a graph comparatively showing the variation of the respective values of hardness of samples in an example of the present invention and a comparative example with bias voltage used for depositing a film; and

FIG. 3 is a typical sectional view of a cemented carbide or silicon (Si) wafer coated with first and second layers.

### DESCRIPTION OF THE PREFERRED EMBODIMENTS

A molding tool in a preferred embodiment according to the present invention is provided with an intermediate film coating a base surface of the molding tool, and a DLC film coating the intermediate film. The intermediate film is formed of a material having a composition represented by (Cr₁₋ₐSiₐ) (BₓC_{y}N_{1-x-y}) meeting conditions expressed by Inequalities:

0.5≦a≦0.95 (1)

0≦x≦0.2 (2)

0≦y≦0.5 (3),

where a is the atomic percent of Si, x is the atomic percent of B, and y is the atomic percent of C, by using a process gas pressure between 0.2 and 0.5 Pa.

The intermediate film is a protective film for protecting the base surface of the molding tool during a DLC film removing process for removing the DLC film. Thus the intermediate film serves as a barrier layer for preventing etching the base surface of the molding tool when the DLC film is removed by an etching process. Therefore the base surface of the molding tool is hard to be etched and the roughening of the base surface by etching can be prevented.

Thus the base surface of the molding tool in the embodiment is scarcely roughened by etching when the DLC film is removed by an etching process and hence the surface roughness of the base surface does not need to be adjusted before depositing a new DLC film on the molding tool.

The base surface of the molding tool needs to be excellent in smoothness and has high hardness to manufacture moldings excellent in surface quality efficiently. If the prevention of etching the base surface of the molding tool is only the purpose of the intermediate film, the intermediate film may be any film having, in so far as it has a barrier effect, a composition not meeting the foregoing conditions to be met by the intermediate film of the present invention. However, the smoothness of the DLC film, namely, the molding surface of the molding tool, is unsatisfactory, if the surface of the intermediate film is unsatisfactory. The hardness of the molding surface of the molding tool is low if the hardness of the intermediate film is low. Therefore, the intermediate film needs to be excellent in surface smoothness and has high hardness in addition to a barrier effect. The composition of the intermediate layer is determined taking into consideration those requirements. The intermediate film of the present invention is excellent in surface smoothness and has high hardness in addition to a barrier effect.

The intermediate film of the molding tool is excellent in surface smoothness and wear resistance, and has high hardness owing to its composition and film forming conditions, such as process gas pressure for an intermediate film forming process. Therefore, the surface of the DLC film is excellent in surface smoothness, and the molding surface of the molding tool has high hardness and excellent in wear resistance.

The surface smoothness of the DLC film is dependent on that of the intermediate film underlying the DLC film. The higher the surface smoothness of the intermediate film, the higher is the surface smoothness of the DLC film overlying the intermediate film. The intermediate film of the molding tool has a surface excellent in surface smoothness and hence the DLC film of the molding tool of the present invention has a surface excellent in surface smoothness; that is, the molding surface of the molding tool of the present invention is excellent in smoothness.

Although the DLC film has high hardness, the molding surface of the molding tool does not have a sufficiently high hardness if the intermediate film has a low hardness. Since the intermediate film of the molding tool of the present invention has high hardness, the molding surface of the molding tool has high hardness and excellent in wear resistance.

The molding tool of the present invention is excellent in surface smoothness and wear resistance, and has high hardness, the base surface of the molding tool is scarcely roughened by an etching process for removing a worn DLC film, and hence the surface roughness adjustment of the base surface of the molding tool before depositing a new DLC film is unnecessary. Thus the roughening of the base surface of the molding tool by the etching process for removing the worn DLC film can be prevented.

Numerical conditions required by the present invention will be described below.

The intermediate film is deposited in amorphous structure and has a smooth surface when the Si content a (at. %) of the intermediate film is 0.5 at. % or above. Therefore, the lower limit of the Si content a is 0.5 at. %. The intermediate film becomes insulating, the deposition of the intermediate film and the DLC film is difficult, and adhesion of the intermediate film to the base surface of the molding tool is low when the Si content a is high. Therefore, the upper limit of the Si content a is 0.95 at. %. Thus the composition of the intermediate film needs to meet 0.5≦a≦0.95, preferably, 0.7≦a≦0.9.

Chromium (Cr) increases the hardness of the intermediate film. Although there are metallic elements, other than Cr, capable of increasing the hardness of the intermediate film, Cr is particularly effective in suppressing the deterioration of the intermediate film and the DLC film during a molding process for molding glass by increasing the hardness. Therefore, Cr is used.

Boron (B) and Cr bond together to produce a CrB compound. The CrB compound increases the hardness of the intermediate film. The intermediate film having a high B content is brittle. Therefore, the B content of the intermediate film is 0.2 at. % or below, preferably, 0.1 at. % or below.

Carbon (C) and Cr bond together to produce a CrC compound. The CrC compound increases the hardness of the intermediate film. The intermediate film having a high C content is brittle. Therefore, the C content of the intermediate film is 0.5 at. % or below, preferably, 0.3 at. % or below.

Nitrogen (N) and Cr bond together to produce a hard nitride. The nitrides are particularly effective in increasing the hardness of the intermediate film and hence N is an essential element. Nitrogen (N) is needed to produce CrN and SiN and to deposit the intermediate film in amorphous structure. The intermediate film of amorphous structure has a smooth surface. A preferable N content 1−x−y (at. %) of the intermediate film is between 0.3 and 1.0 at. %, more desirably, between 0.5 and 0.7 at. %.

Thus the intermediate film is formed of a material having a composition represented by (Cr₁₋ₐSiₐ) (BₓC_{y}N_{1-x-y}) meeting conditions expressed by Inequalities (1), (2) and (3).

The intermediate film of the molding tool of the present invention is specified by a film forming condition as well as the composition. A process gas pressure for depositing the intermediate film is between 0.2 and 0.5 Pa. The intermediate film is excellent in surface smoothness and has high hardness when the process gas pressure is between 0.2 and 0.5 Pa. The hardness and surface smoothness of the intermediate film are low if the process gas pressure is above 0.5 Pa. A plasma for film deposition is unstable and it is possible that the intermediate film cannot be deposited if the process gas pressure is below 0.2 Pa. Therefore, a preferable process gas pressure is between 0.2 and 0.5 Pa, desirably, between 0.2 and 0.4 Pa.

It is preferable that the surface roughness Ra of the molding surface of the molding tool is 3 nm or below when the molding tool is intended for molding a lens having a smooth surface. The smoothness of even the surface of the intermediate film of an amorphous structure is unsatisfactory and the surface roughness Ra of the molding surface of the molding tool is not 3 nm or below when the thickness of the intermediate film is above 1000 nm. The protective effect of the intermediate film is low and the intermediate film may be removed by the DLC film removing process if the thickness of the intermediate film is below 20 nm. If the intermediate film is removed, a new intermediate film needs to be deposited on the molding tool. Therefore, it is desirable that the thickness of the intermediate film is between 20 and 1000 nm.

As mentioned above, the base surface of the conventional molding tool is roughened by the etching process for removing the DLC film and hence the surface roughness of the base surface needs to be adjusted before depositing anew DLC film. Surface roughness adjustment requires much time and cost. The molding surface of a molding tool for molding a glass lens or a resin molding, in particular, needs to be very excellent in surface smoothness. Therefore, the adjustment of the surface roughness of the base surface of such a molding tool requires particularly much time and cost. The base surface of the molding tool of the present invention is scarcely roughened by the etching process for removing the DLC film, and hence the surface roughness of the base surface of the molding tool does not need to be adjusted before depositing a new DLC film. Thus the molding tool of the present invention can be particularly effectively applied to molding a glass lens or a resin molding.

The removal of the worn DLC film and the deposition of a new DLC film are carried out by the following methods. The worn DLC film is removed by a dc glow discharge etching process. The dc glow discharge etching process uses a bias voltage of 400 V, a process gas pressure of 4 Pa, an ambient atmosphere containing 50% Ar and 50% N₂, and an etching time of 4 hr. After the DLC film has been removed by the dc glow discharge etching process and the surface of the intermediate film has been exposed, the surface of the intermediate film is etched uniformly without roughening the surface of the intermediate film. Anew intermediate film does not need to be deposited, provided that the dc glow discharge etching process is terminated upon the exposure of the surface of the intermediate film. A new DLC film is deposited after thus removing the worn DLC film. If the intermediate film is etched excessively and the base surface of the molding tool is exposed by a wrong etching operation, such as the continuation of the dc glow discharge etching process beyond a predetermined etching time, the surface roughness of the base surface of the molding tool needs to be adjusted and a new intermediate film needs to be deposited before depositing a new DLC film. Therefore, it is necessary that the dc glow discharge process be monitored to prevent etching the base surface of the molding tool excessively by a wrong etching operation. Excessive etching of the base surface of the molding tool roughens the base surface because the components of the base surface of the molding tool are selectively etched. If the molding tool is made of a steel of the SKD grade containing Co, Co is removed from the base surface by selective etching.

A hard film excellent in lubricity and wear resistance in a watery environment mentioned in JP-A 2004-292835 has a composition represented by: (M₁₋ₓSiₓ) (C_{1-d}N_{d}) meeting inequalities: 0.45≦x≦0.95 and 0≦d≦1, where M is at least one of elements of groups 3A, 4A, 5A and 6A, and Al. The composition of one of the hard films mentioned in JP-A 2004-292835 containing Cr as M is identical with that of the intermediate film of the molding tool of the present invention. However, this known hard film is intended to improve the lubricity and wear resistance of a sliding member of a device using water as a working medium and is not intended for use on a molding tool. Therefore, nothing is discussed at all about surface smoothness and means for providing a smooth surface needed by a molding tool. Therefore, application of this known hard film to members required to be excellent in lubricity and wear resistance in a watery environment and members required to have high hardness can be readily thought and this known hard film is suitable for such uses. Application of this known hard film to a molding tool required to have high hardness and to be excellent in surface smoothness cannot be readily thought. It is still less possible to have an idea of using this known hard film as the intermediate film to be formed between the base surface of the molding tool and the DLC film. Even if the application of this known hard film to the intermediate film is thought, a molding tool like the molding tool of the present invention having high hardness and excellent in surface smoothness cannot be provided simply by replacing the intermediate film with this known hard film or by simply adding this known hard film to the molding tool. The composition of the intermediate film of the molding tool of the present invention is specified in view of hardness, adhesion and surface smoothness, and the intermediate film is deposited under a specified film forming condition, namely, a process gas pressure between 0.2 and 0.5 Pa. Thus the present invention cannot be readily made on the basis of the inventions disclosed in JP-A 2005-342922 and JP-A 2004-292835.

### EXAMPLES

Examples of the present invention and comparative examples will be described.

### Example 1

Films respectively having compositions shown in Table 1 were deposited by a two-material simultaneous sputtering process by a sputtering system provided with a sputtering target placed in a sputtering chamber. Mirror-finished substrate of a cemented carbide was used as bases to make samples for composition analysis and adhesion testing. The substrate was placed in the sputtering chamber and the sputtering chamber was evacuated to a pressure of 1×10⁻³ Pa or below. The substrate heated at about 400° C. was cleaned by a sputter cleaning process using Ar ions. A sputtering target of 6 in. in diameter was used. Power supplied to the target containing Cr, or Cr and B was varied in a range between 0.5 and 3.0 kW and power supplied to the target containing Si was varied in a range between 0.5 and 2 kW to adjust the composition of a deposited film. A mixed gas containing 65 parts A4 and 35 parts N₂ or a mixed gas containing Ar, N₂ and CH₄ was used for film deposition. The pressure of the gas in the sputtering chamber was regulated at 0.2 Pa. A fixed bias voltage of −50V was applied to the substrate for film deposition. All the films were formed in a fixed thickness of about 600 nm. The pressure of 0.2 Pa is within the range of 0.2 to 0.5 Pa specified by the present invention.

The composition of the film deposited on the substrate was analyzed by EDX using a SEM (Model S-3500N, Hitachi). The hardness of the film was measured by a nanoindentation technique using TRIBOSCOPE (HYSITRON) provided with a Berkovich indenter, namely, a diamond-pyramid indenter. A load-unload curve was obtained by using a measuring load of 1000 μN, and a hardness was calculated. A scanning area of 2 μm×2 μm in the surface of a sample was scanned with an atomic force microscope (AFM) for the three-dimensional measurement of irregularities on the order of nanometers to calculate a surface roughness Ra. The crystal structure of a sample formed by coating the surface of a cemented carbide substrate with a film was determined by using an x-ray diffractometer (XRD). In the x-ray diffraction analysis, the angle 2θ=30° to 50°. It was decided that the surface of the substrate was coated with a crystalline film when diffracted rays other than those originating in the substrate were detected. It was decided that the surface of the substrate was coated with a film of amorphous structure when any diffracted rays other than those originating in the substrate were not detected.

Results of analysis of the composition of each of the films, measured hardness of each of the films, measured surface roughness Ra of each of the films and determined crystal structure of a sample formed by coating the surface of a cemented carbide substrate with a film are shown in Table 1. The process gas pressure used for depositing sample films shown in Table 1 was 0.2 Pa, which is in the range of 0.2 to 0.5 Pa specified by the present invention. Each of the sample films Nos. 4 to 6, 14 and 16 has a composition meeting the conditions on the composition of the intermediate film of the present invention. Each of the sample films Nos. 1 to 3, 7, 15, 17 and 18 has a composition not meeting the conditions on the intermediate film of the present invention. Some of the sample films having a composition not meeting the conditions on the intermediate film of the present invention have a crystalline structure, a large surface roughness Ra, low surface smoothness and a low hardness. The sample films meeting the conditions on the intermediate film of the present invention have an amorphous structure, a very small surface roughness Ra, excellent surface smoothness and a high hardness.

The surface of a coating structure formed by coating the sample film with a DLC film, namely, the surface of the DLC film, had a large surface roughness Ra and low surface smoothness when the sample film had low surface smoothness or had a small surface roughness Ra and excellent surface smoothness when the sample film had high surface smoothness. The coating structure had low hardness when the sample film had low hardness or had high hardness when the sample film had high hardness. When the sample film was excellent in surface smoothness and had high hardness, the surface of the coating structure, namely, the surface of the DLC film overlying the sample film, had a small surface roughness Ra, excellent surface smoothness and high hardness.

### Example 2

Sample films having a composition represented by (Cr_{0.1}Si_{0.9})N were formed on substrates. Dependence of the surface roughness and hardness of the films on film deposition conditions was studied. The sample film was formed on a mirror-finished cemented carbide substrate to obtain a sample for the analysis of the composition of the sample film and measurement of the adhesion of the sample film to the substrate. The substrate was placed in a sputtering chamber, and then the sputtering chamber was evacuated to 1×10⁻³ Pa or below. The substrate was heated at about 400° C. and the surface of the substrate was cleaned by a sputter cleaning process using Ar ions. A mixed gas containing 65 parts Ar and 35 parts N₂ was used for film deposition. Pressures in the range of 0.2 to 0.6 Pa were used. Bias voltages in the range of 0 to −200V were applied to the substrates. The sample films were formed in a fixed thickness of about 600 nm. The composition of each of the sample films met the conditions on the composition of the intermediate film of the present invention.

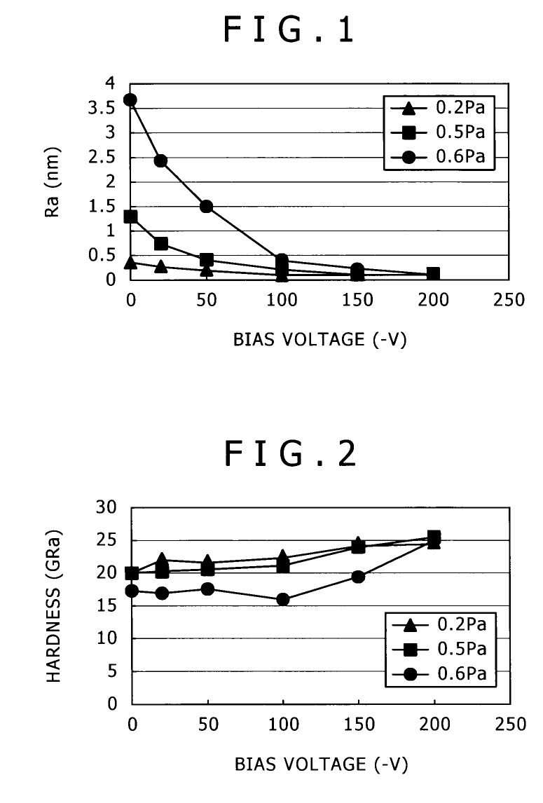

The surface roughness and hardness of each of the sample films was measure by the same methods as those employed in measuring those of the sample films in Example 1. Measured results are shown in FIGS. 1 and 2. FIG. 1 shows the dependence of surface roughness on bias voltage for process gas pressures. FIG. 2 shows the dependence of hardness on bias voltage for process gas pressures. As obvious from FIGS. 1 and 2, the surface of the sample film was not satisfactorily smooth and the hardness was low unless a high bias voltage was applied to the substrate when the process gas pressure was 0.6 Pa. The surface roughness Ra was 1.5 nm or below and the hardness was 20 GPa or above and the sample films had a smooth surface and high hardness even if any bias voltage was not applied to the substrate when the process gas pressure was 0.5 Pa or below.

The surface of a coating structure formed by coating the sample film with a DLC film, namely, the surface of the DLC film, had a large surface roughness Ra and low surface smoothness when the sample film had low surface smoothness. The coating structure formed by depositing the DLC film on the sample film having low hardness had low hardness. The surface of the coating structure, namely, the surface of the DLC film, had a small surface roughness Ra and excellent surface smoothness and the coating structure had high hardness when the sample film was excellent in surface smoothness and had high hardness.

### Example 3

Intermediate films (first layer) of CrSiN each having a thickness between 10 and 1500 nm were formed on substrates, and a DLC film (second layer) having a thickness of 1000 nm was formed on each of the intermediate films to obtain samples for adhesion evaluation and surface roughness measurement. Mirror-finished cemented carbide substrates were used for forming the samples for adhesion evaluation. Si substrates were used for forming the samples for surface roughness measurement. The substrate was placed in the sputtering chamber and the sputtering chamber was evacuated to a pressure of 1×10⁻³ Pa or below. The substrate heated at about 400° C. was cleaned by a sputter cleaning process using Ar ions. A sputtering target of 6 in. in diameter was used. Power of 0.2 kW was supplied to the Cr target and power of 2.0 kW was supplied to the Si target for film deposition. A mixed gas containing 65 parts Ar and 35 parts N₂ was used for film deposition. The pressure of the gas in the sputtering chamber was regulated at 0.2 Pa. A bias voltage of −100V was applied to the substrate for film deposition. The intermediate films thus deposited had a composition represented by (Cr_{0.1}Si_{0.9})N and the composition of each of the sample intermediate films met the conditions on the composition of the intermediate film of the present invention stated in claim 1.

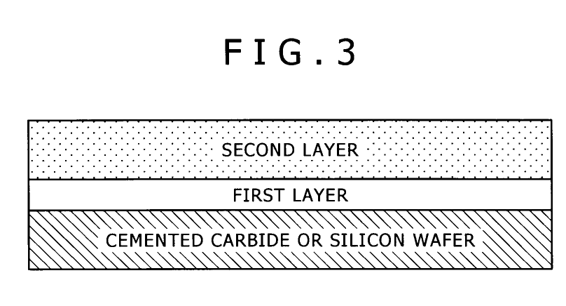

A target of 6 in. in diameter was used and power of 1.0 kW was supplied to the target for depositing the DLC film. A mixed gas containing 90 parts Ar and 10 parts CH₂ was used for film deposition. Process gas pressure was regulated at 0.6 Pa and a bias voltage of −50 V was used. DLC films were formed in a fixed thickness of 1000 nm. FIG. 3 shows a coating structure formed by depositing the DLC film (second layer) on the intermediate film (first layer). All the coating structures met the conditions specified by the present invention stated in claim 1. Some of the coating structures do not meet the conditions stated in claim 2 and others meet the same.

The adhesion of the coating structures each formed by depositing the DLC film on the intermediate film to the substrate was evaluated. The adhesion was evaluated by a scratch test using a diamond indenter having a round tip of 200 μm in radius. Conditions for the scratch test were load in the range of 0 to 1000 N, scratch speed of 1.0 cm/min and loading rate of 100 N/min. A critical load Lc1 applied at the moment the coating structure starts coming off was measured. The adhesion was evaluated in terms of the critical load Lc1. The surface roughness of the DLC films was measured by the same method as that employed in measuring the surface roughness of the sample films in Example 1.

Table 2 shows results of measurement of the adhesion of the films and the surface roughness of the DLC films. As obvious from Table 2, the DLC film had a small surface roughness Ra and was excellent in surface smoothness, but had a low Lc1 and low adhesion when the thickness of the intermediate film (first layer) is 10 nm. The DLC film had a large surface roughness Ra, low surface smoothness, a small Lc1 and low adhesion when the thickness of the intermediate film (first layer) is 1500 nm. The DLC film had a small surface roughness Ra, excellent surface smoothness, a large Lc1 and excellent adhesion when the thickness of the intermediate film (first layer) is in the range of 20 to 1000 nm.

TABLE 1

| | Composition | | | | | | Surface | |
|---|---|---|---|---|---|---|---|---|
| | 1 − a | a | x | y | 1 − x − y | Hardness | roughness | |
| Sample No. | Cr | Si | B | C | N | (GPa) | RA (nm) | Structure |
| 1 | 1 | 0 | 0 | 0 | 1 | 14.3 | 3.54 | Crystalline |
| 2 | 0.93 | 0.07 | 0 | 0 | 1 | 16 | 3.32 | Crystalline |
| 3 | 0.56 | 0.44 | 0 | 0 | 1 | 16.7 | 3.21 | Crystalline |
| 4 | 0.47 | 0.53 | 0 | 0 | 1 | 21.1 | 0.35 | Amorphous |
| 5 | 0.25 | 0.75 | 0 | 0 | 1 | 22 | 0.54 | Amorphous |
| 6 | 0.1 | 0.9 | 0 | 0 | 1 | 22 | 0.22 | Amorphous |
| 7 | 0 | 1 | 0 | 0 | 1 | 21 | 3.11 | Crystalline |
| 14 | 0.1 | 0.9 | 0 | 0.36 | 0.64 | 19.2 | 0.22 | Amorphous |
| 15 | 0.1 | 0.9 | 0 | 1 | 0 | 16 | 3.76 | Crystalline |
| 16 | 0.1 | 0.9 | 0.15 | 0.24 | 0.61 | 20.5 | 0.45 | Amorphous |
| 17 | 0.1 | 0.9 | 0.25 | 0 | 0.75 | 16 | 3.12 | Crystalline |
| 18 | 0.1 | 0.9 | 0 | 0.53 | 0.47 | 17 | 3.56 | Crystalline |

TABLE 2

| Sample | Thickness of | Adhesion | Surface |
|---|---|---|---|
| No. | first layer (nm) | Lc1 (N) | roughness Ra (nm) |
| 1 | 10 | 25 | 0.45 |
| 2 | 25 | 77 | 0.48 |
| 3 | 100 | 71 | 0.53 |
| 4 | 400 | 70 | 0.66 |
| 5 | 900 | 66 | 0.87 |
| 6 | 1500 | 28 | 3.45 |

The molding tool of the present invention has the base surface hard to be roughened by an etching process for removing the DLC film. Therefore, the base surface of the molding tool does not need to be processed by a surface roughness adjusting process before depositing a new DLC film on the base surface. Thus the worn DLC film can be easily removed and a new DLC film can be deposited in a short time, and hence the cost of removing the worn DLC film and depositing a new DLC film can be reduced.

Although the invention has been described in its examples with a certain degree of particularity, obviously many changes and variations are possible therein. It is therefore to be understood that the present invention may be practiced other wise than as specifically described herein with out departing from the scope and spirit thereof.

What is claimed is:

1. A molding tool provided with an intermediate film coating a base surface of the molding tool, and a diamondlike carbon film coating the intermediate film;
wherein the intermediate film is formed of a material having a composition represented by (Cr₁₋ₐSiₐ) (BₓC_{y}N_{1-x-y}) meeting conditions expressed by inequalities:
0.5≦a≦0.95 (1)
0≦x≦0.2 (2)
0≦y≦0.5 (3),
where a is the atomic percent of Si, x is the atomic percent of B, and y is the atomic percent of C, by using a process gas pressure between 0.2 and 0.5 Pa.

2. The molding tool according to claim 1, wherein the intermediate film has a thickness between 20 and 1000 nm.
